(19) United States
(12) Patent Application Publication
(10) Pub. No.: US 2005/0274196 A1
(43) Pub. Date: Dec. 15, 2005

(54) Luminescent nanochannel sensor

(76) Inventors: Tatsuya Uchida, Tokyo (JP); Norio Teramae, Miyagi (JP); Yasuo Suto, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/518,755

(22) PCT Filed: Sep. 5, 2003
(86) PCT No.: PCT/JP03/11384

§ 371 Date: Aug. 1, 2005

(30) Foreign Application Priority Data
Sep. 5, 2002 (JP) 2002-260503

(51) Int. Cl. G01L 1/24

(52) U.S. Cl. 73/800

(57) ABSTRACT

In a nanochannel thin film in which oxide layers have surfactant micelles therein, the presence of a target substance in a sample solution is detected with a luminescence intensity of a thin film provided by recognition of the target substance with a luminescent recognition reagent in the nanochannels. Upon focusing on a hydrophobic field provided by the presence of the surfactant in pores of a nanometer size, the novel development of a sensor function is enabled.

### TECHNICAL FIELD

The invention of this application relates to a luminescent nanochannel sensor. More specifically, the invention of this application relates to a novel luminescent nanochannel sensor using a porous (nanochannel) structure of a nanometer size which is useful in a wide-ranging field of medicine, hygiene, industry, agriculture, environmental evaluation and the like as a sensor for biochemical analysis, trace analysis and the like.

### BACKGROUND ART

Upon focusing on pores of a nanometer size, production of the porous (mesoporous) substances has been so far studied. In these ordinary studies, porous substances are formed using a surfactant as a matrix by hydrolyzing an alkoxysilane compound in the presence of the surfactant. For example, as the ordinary techniques, formation of a mesoporous substance on a mica substrate (document 1), formation of a mesoporous thin film by evaporation of a solvent (document 2), patterning of a mesoporous thin film and functioning by a silane coupling agent (document 3) and the like have been reported.

Document 1: Hong Yang, et al., Nature, Vol. 379, 22 Feb. 1996, p. 703-705

Document 2: Yun Feng Lu, et al., Nature, Vol. 389, 25 Sep. 1997, p. 364-368

Document 3: Hongyou Fan, et al., Nature, Vol. 405, 4 May 2000, p. 56-60

In spite of, for example, the foregoing studies, the technical development of substances having pores of a nanometer size and of their use as functional materials for thin films has hardly progressed at present, though the use as a pH sensor or the like has been suggested. For example, ultramicroanalysis using a porous structure of a nanometer scale or the like has been expected to be realized, but has not been materialized as yet.

One of the reasons therefor is that in the ordinary techniques, a surfactant is used as a matrix for formation of pores, but this surfactant is removed by calcination and no attention is drawn to a hydrophobic field with a surfactant. For the development of the function as an analytical sensor or the like, more interest has to be aroused in this hydrophobic field.

Under such circumstances, the invention of this application has been made, and it aims to provide a novel technical means that enables the development of a substance having pores of a nanometer size for a sensor as its function upon focusing on a hydrophobic field given by the presence of a surfactant used during production of the substance.

### DISCLOSURE OF INVENTION

The invention of this application first provides, for solving the foregoing problems, a luminescent nanochannel sensor which is a nanochannel sensor having a nanochannel thin film in which oxide layers have surfactant micelles therein, characterized in that the presence of a target substance in a sample solution is detected with a luminescence intensity of the thin film provided by recognition of the target substance with a luminescent recognition reagent in the nanochannels.

The invention of this application second provides the luminescent nanochannel sensor characterized in that the oxide layer of the nanochannel is made mainly of silicon oxide, third provides the luminescent nanochannel sensor characterized in that the luminescent recognition reagent and the sample solution are mixed, the luminescent recognition reagent and the target substance recognized therewith are extractively trapped in the nanochannels, and the presence of the target substance in the sample solution is detected with the luminescence intensity of the thin film, and fourth provides the luminescent nanochannel sensor characterized in that the nanochannels are previously impregnated with the luminescent recognition reagent, and the presence of the target substance in the sample solution is detected with the luminescence intensity of the thin film provided by the trapping recognition.

### BRIEF DESCRIPTION OF DRAWINGS

FIG. 1 is a view schematically showing a nanochannel thin film.

FIG. 2 is a view schematically showing extraction-type and impregnation-type sensors.

FIG. 3 is a graph showing results of X-ray diffraction of a nanochannel thin film in Example.

FIG. 4 is a graph showing a relationship of a TEOS content and a film thickness in Example.

FIG. 5 is a view showing a molecular structure of 8-quinotanol-5-2 sulfonic acid (Qs).

FIG. 6 is a graph showing a dependence of a luminescence spectrum (thin film) on an aluminum concentration.

FIG. 7 is a graph showing a response of a luminescent nanochannel sensor (extraction type) to an aluminum ion.

FIG. 8 is a graph showing a relative ratio of a luminescence intensity to an aluminum ion concentration up to 5 μM.

FIG. 9 is a view showing a mechanism of extracting an aluminum-quinolinol complex in a micelle within a nanochannel.

FIG. 10 is a graph showing a response of a luminescent nanochannel sensor (extraction type) to a magnesium ion.

FIG. 11 is a graph showing a response of a luminescent nanochannel sensor (impregnation type) to a magnesium ion.

FIG. 12 is a graph showing results of measuring a luminescent response to a potassium ion and a sodium, ion.

FIG. 13 is a graph showing correspondence of an aluminum ion concentration and a luminescence intensity on luminescence given by a sensor array.

FIG. 14 is a photograph showing a luminescent image provided with a sensor array.

FIG. 15 is a photograph showing a luminescent image provided by simultaneous analysis of two elements (ions) with a sensor array.

### BEST MODE FOR CARRYING OUT THE INVENTION

The invention of this application has the foregoing characteristics, and the embodiments thereof are described below.

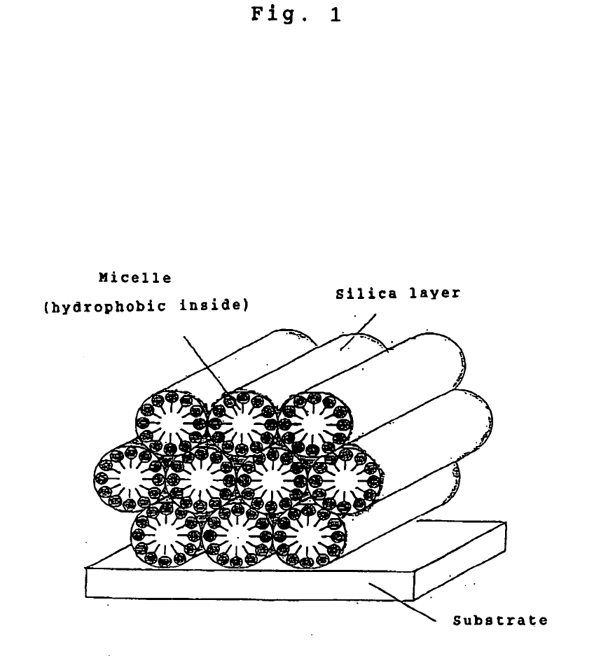

Most characteristic in the invention of this application are that in the structure of the nanochannel sensor, the oxide layers have surfactant micelles therein to retain the inside of the nanochannels as a hydrophobic field and that the target substance in the sample solution is detected with the luminescence intensity of the nanochannel thin film provided by recognition of the target substance with the luminescent recognition reagent in this hydrophobic field. The nanochannel thin film which makes it possible to provide such a specific structure and the function thereof is considered to be formed as schematically shown in, for example, FIG. 1, in case of silica layers.

The nanochannels can preferably be produced from an acid alcohol solution containing an oxide-forming alkoxide compound and a surfactant as a raw material by heating or drying such that the oxide layers have the surfactant micelles therein. Generally, when the concentrations of the starting materials in the solution are relatively low, the micelles are formed during evaporation to dryness, and these become a matrix to form the nanochannels. Meanwhile, when the concentrations of the starting materials are high, the starting materials and the like are melted at a high temperature under elevated pressure, and the nanochannels are formed during this process.

At this time, as the oxide-forming alkoxide compound, various compounds are available so long as the oxide layers of the nanochannel structure are thereby formed. A typical example thereof is a silicon alkoxide compound with which to form silicon oxide layers. Further, various alkoxides of titanium, zirconium, hafnium, tantalum, niobium, gallium, rare earth elements and the like can be considered.

As the surfactant used along with these alkoxide compounds, various surfactants may be considered. A typical example thereof is a quaternary ammonium salt-type surfactant as an ionic surfactant. Further, a sulfonic acid-type surfactant is available. A polyether-type nonionic surfactant may also be used. However, one of the preferable surfactants is a cationic quaternary ammonium salt-type surfactant.

The use ratio of the alkoxide compound and the surfactant varies depending on the types of the two, and is not particularly limited. Generally, it can be set at from 0.01 to 0.5 as a standard in terms of a molar ratio of the surfactant to the alkoxide compound.

The alkoxide compound and the surfactant are mixed and heated in the acid aqueous solution. At this time, the heating temperature can be up to a refluxing temperature. For providing acidic conditions, hydrochloric acid, sulfuric acid or an organic acid can be mixed. It is preferable that low-boiling alcohols such as ethanol, propanol and methanol are present in the aqueous solution.

After the heating, the nanochannels in the invention of this application are formed. At this time, the heated solution may be spread on a solid substrate, or the solution may be heated on the solid substrate. In this manner, the thin product of the nanochannels schematically shown in FIG. 1 is obtained. This can be called a thin film. Of course, the solid substrate can include various substrates. Examples thereof can include ceramics substrates such as mica-alumina, glass substrates, metallic substrates and organic polymeric substrates.

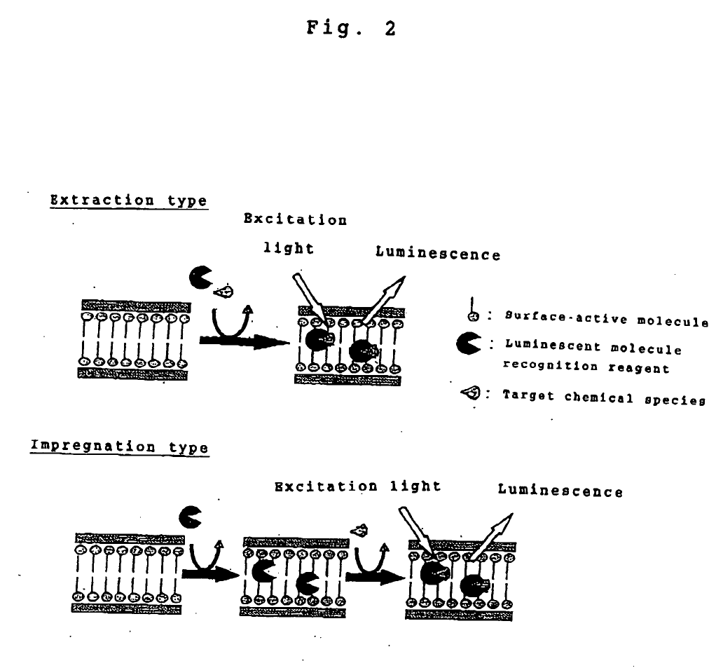

The luminescent nanochannel sensor of the invention of this application is formed of the nanochannel thin film in which the oxide layers have the surfactant micelles therein and which can be produced by the foregoing process. The type thereof is roughly classified into an extraction type and an impregnation type. FIG. 2 schematically shows the outline thereof.

In the extraction type, for example, the luminescent recognition reagent is dissolved in the sample aqueous solution. While the solution and the target substance are complexed, the complex is extracted into the nanochannel through hydrophobic interaction, and the target substance is detected on the basis of the luminescence intensity of the thin film. Meanwhile, in the impregnation type, the luminescent recognition reagent is previously introduced from its aqueous solution to the nanochannels. Thereafter, the target substance in the sample aqueous solution is trapped with the luminescent recognition reagent present in the channels, and the target substance is detected on the basis of the luminescence intensity of the film. In this impregnation type, many types of chemical substances can simultaneously be detected by arranging nanochannel thin films having different recognition reagents on one and the same substrate.

In both of these cases, various luminescent recognition reagents can be used and include a reagent capable of complexing with the target substance, a reagent capable of binding by a reaction, a reagent capable of physical trapping and binding, and the like. In the hydrophobic field of the nanochannel, luminescent recognition reagents having various functional groups in the molecular structure can be used. In these luminescent recognition reagents, the luminescence function can be provided by various methods. Further, these reagents may be not only low-molecular compounds but also high-molecular or biological compounds such as DNA, proteins and enzymes.

When the nanochannels are impregnated with water or the aqueous solution, a part of the surfactant micelles enclosed in the nanochannels (pores) are eluted into water or the aqueous solution to decrease the hydrophobicity of the nanochannels over the course of time. Accordingly, in the invention of this application, as a method for maintaining the hydrophobicity of the nanochannels, it is also effective that the inner walls of the nanochannels are previously hydrophobized to increase the hydrophobic interaction between the surfactant micelles and the inner walls thereof and thereby suppress the elution of the surfactant micelles into water or the aqueous solution.

For this hydrophobization, a hydrophobizing agent can be used in consideration of an affinity for the nanochannels or the like. For example, when the nanochannels are formed of silicon oxide, an appropriate silane coupling agent, more specifically, a silane coupling agent having a mercapto group is considered to be an appropriate agent.

The conditions for this hydrophobization can properly be selected experimentally. In a more preferable method, it is considered to incorporate the hydrophobizing agent along with the surfactant at the time of forming the nanochannels in the production of the foregoing nanochannel structure or nanochannel thin film in the invention of this application.

With respect to the use ratio relative to the alkoxide compound and the surfactant for the formation of the nanochannels, it is considered that the hydrophobizing agent such as a silane coupling agent is used at a molar ratio of from 0.3 to 1.2 relative to the former and at a molar ratio of from 3 to 20 relative to the latter.

The detection of the fluorescence intensity of the nanochannel thin film may be conducted by, as shown in FIG. 2, for example, measuring the change in luminescence intensity caused by applying excitation light or according to the other luminescence mechanism and its detecting method.

The embodiment of the invention is described in more detail below by referring to Example. Of course, the invention is not limited by the following Example.

### EXAMPLE

1. Production of a Nanochannel Thin Film

A silica surfactant nanochannel thin film having a porous (nanochannel) structure of a nanometer size was produced in the following manner using a surface-active molecule assembly (micelles) as a matrix.

<Preparation of a Thin Film-Forming Solution>

A composition (molar ratio) of a solution was as follows.

TEOS:EtOH:H₂O:HCl:CTAB=1:8.8:5.0:0.004:0.075

CTAB: cetyltrimethylammonium bromide

TEOS: tetraethyl orthosilicate

(1) 9.7 mL of EtOH, 12.3 mL of TEOS and mL of 2.78×10⁻³ M HCl were mixed, and refluxed at 60° C. for 90 minutes.

(2) 18.4 mL of EtOH, 1.519 g of CTAB and 4 mL of 5.48×10hu −2 M HCl were added to the refluxed solution, and the mixture was stirred for 30 minutes.

<Formation of a Thin Film>

(1) 350 μL of the thin film solution obtained by the foregoing production was dropped on a glass substrate washed and dried, and

(2) spin-coating was conducted (4,000 rpm, 30 sec).

<Drying of the Thin Film>

After the spin-coating, the resulting product was dried at room temperature for 1 hour.

<Alkali Treatment> (Neutralization of HCl Contained in the Thin Film)

Alkaline buffer solution (NH₄Cl—NH₃) to be used

0.1 M NH₄Cl and 0.1 M NH₃aq were mixed (pH approximately 10).

(1) The dried thin film was impregnated with the alkaline buffer solution for 20 minutes.

(2) While the alkaline buffer solution was replaced with ultrapure water, the thin film was rinsed, and impregnated with ultrapure water for 20 minutes.

2. Characterization of the Thin Film

<X-Ray Diffraction>

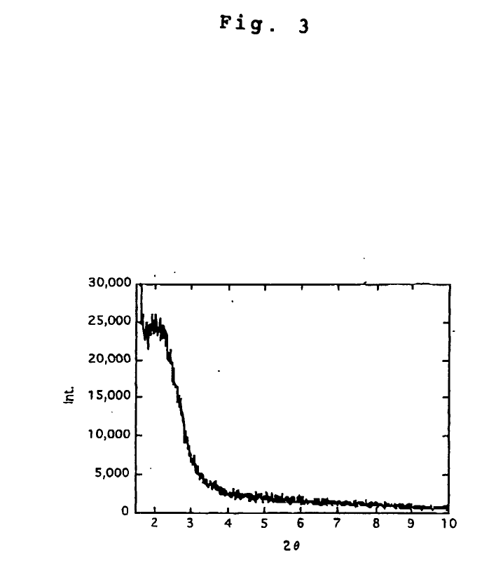

With respect to the thin film obtained by the foregoing process, the results of X-ray diffraction thereof were shown in FIG. 3. A peak is observed at 2 θ of 2.0, and it is found that a periodic structure of a nanometer order is formed in the thin film. The nanochannels are considered to form a honeycomb-like structure as shown in FIG. 1, and a distance between adjacent channels is calculated to be 5.1 nm from this 2 θ value. When the thickness of the silica wall is defined as 1 nm, the pore diameter of the channel is presumably 4 nm. Further, by the simultaneous measurement of X-ray diffraction and differential scanning calorimetry, it was identified that the surface-active molecule was present within the channels up to 300° C. and there was no clear change in micro-order structure.

<Film Thickness>

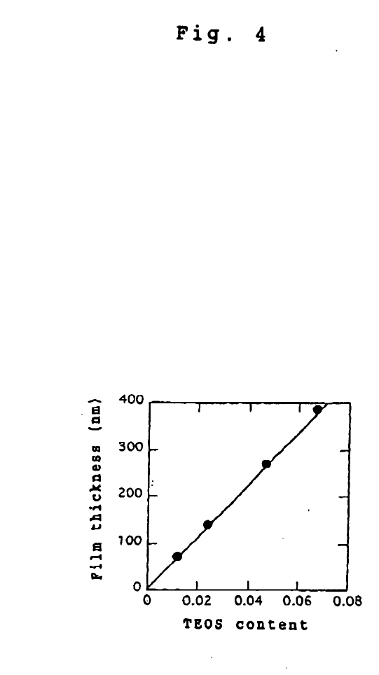

Film thicknesses obtained by ellipsometry and measurement of difference in level using an atomic force microscope were nearly the same, and approximately 390 nm. Subsequently, the thin film-forming solution was diluted with ethanol to try the control of the thin film. In FIG. 4, the film thickness is plotted against the molar ratio of TEOS in the thin film-forming solution. The film thickness was found to be almost proportional to the TEOS content.

3. Detection of an Aluminum Ion with an Extraction Type

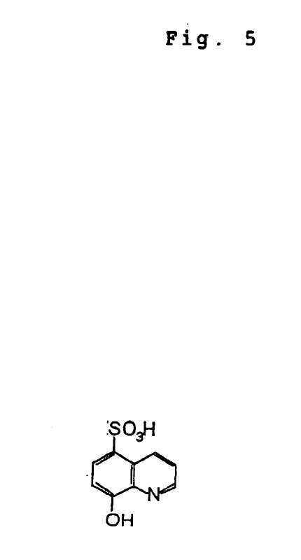

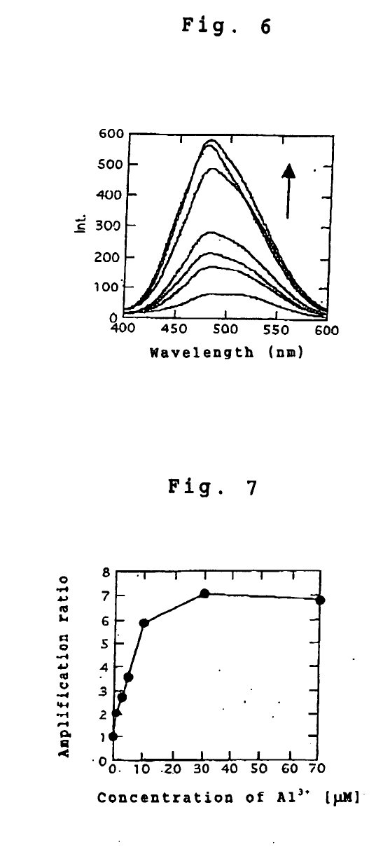

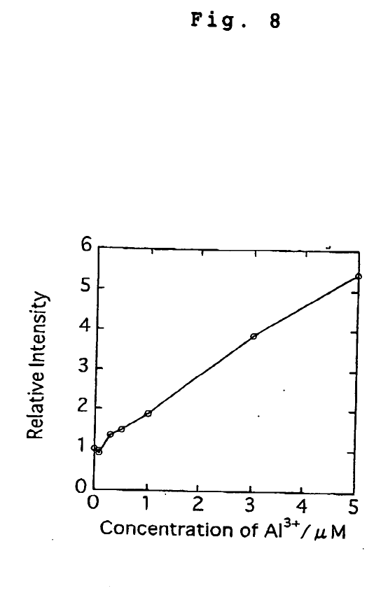

The nanochannel thin films containing the surface-active molecule assembly (micelles) which films were formed on the substrates according to the foregoing process were impregnated, along with the glass substrates, with the aluminum aqueous solutions containing 20 μM of 8-quinolinol-5-sulfonic acid (Qs) of FIG. 5 with different aluminum concentrations for 20 minutes, and dried with air. The luminescence spectrum and intensity were then measured in the ambient atmosphere. The dependence of the luminescence spectrum on the aluminum concentration was shown in FIG. 6, and the graph in which an amplification ratio of the luminescence intensity (the absence of an aluminum ion was defined as 1) was plotted against the aluminum ion concentration was shown in FIG. 7. It is found that the luminescence intensity is increased with the aluminum ion concentration and it is increased up to approximately 7 times at the concentration of approximately 30 μM.

FIG. 8 shows the relative ratio of the luminescence intensity to the aluminum ion concentration up to 5 μM. This graph reveals that it is possible to detect the aluminum ion at the concentration of less than 1 μM.

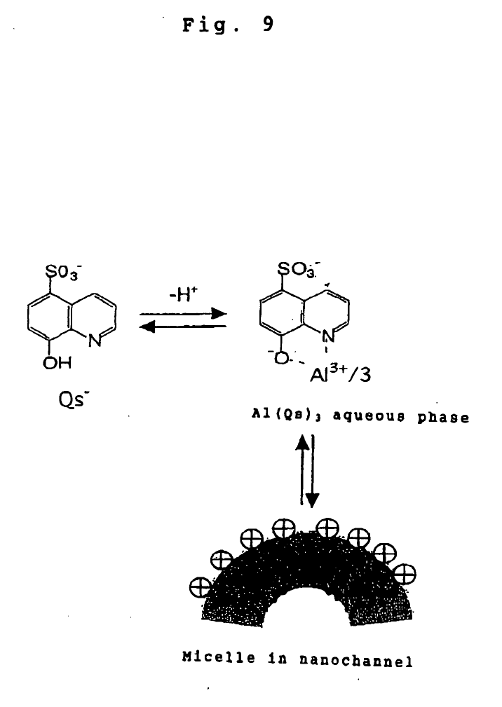

The foregoing results indicate that as shown in FIG. 9, Qs and Al in the sample solution are trapped in the micelles within the nanochannels while being complexed and the amounts thereof are increased according to the Al concentration. These results prove that the aluminum ion in the order of μM (approximately ppb) and in the order of less than μM can be detected at quite a high sensitivity and with ease.

4. Detection of a Magnesium Ion with an Extraction Type

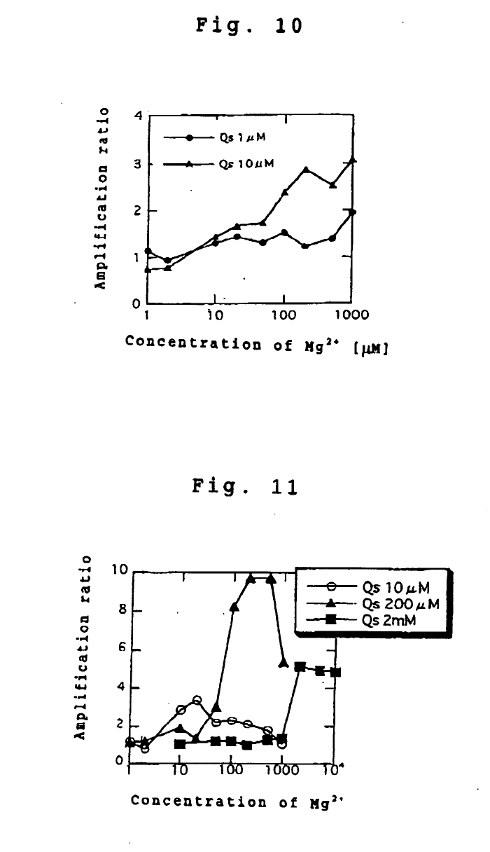

The same thin film substrates as used above were impregnated with magnesium aqueous solutions containing predetermined amounts (1 μM and 10 μM) of Qs with different magnesium concentrations for 20 minutes, and dried with air. Then, the fluorescence spectrum and intensity were measured in the ambient atmosphere. The results were shown in FIG. 10. In case of both of the Qs concentrations, the luminescence intensity is found to be increased according to the Mg concentration in the 3-order-different range of the Mg concentration. From this fact, it is understood that the measurement concentration range of the sensor in the invention of this application is quite wide and the substance detection method in the wide dynamic range is provided. The higher the Qs concentration, the better the amplification ratio of the luminescence intensity to the Mg concentration.

5. Detection of a Magnesium Ion with an Impregnation Type

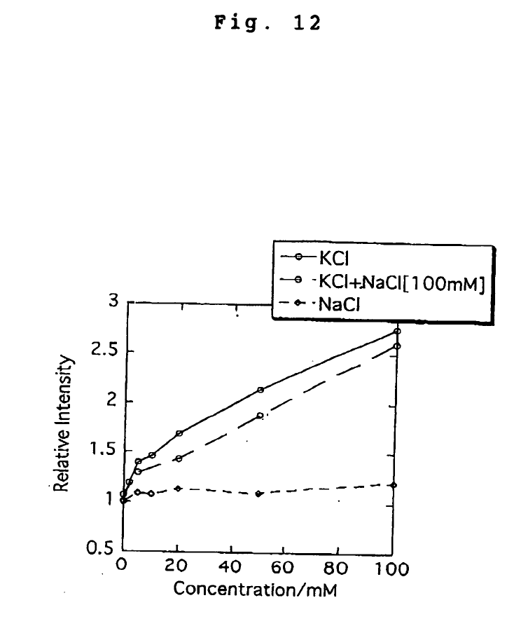

The same thin film substrates as used above were employed, and impregnated respectively with Qs aqueous solutions having concentrations of 10 μM, 200 μM and 2 mM for 20 minutes. The concentration of Qs with which to impregnate the nanochannels was thereby controlled. These substrates were impregnated with Mg aqueous solutions having different concentrations for 20 minutes, and dried with air. The luminescence spectrum and intensity were then measured in the ambient atmosphere. The results were shown in FIG. 11. It is found that in any of the Qs treating concentrations, the amplification ratio is not simply increased but has a maximum at a certain Mg concentration. Further, the Mg concentration at which to give the maximum is increased according to the Qs treating concentration. This result shows that the optimum detection concentration range of the sensor to magnesium can be controlled by changing the Qs treating concentration. This means that the optimum detection concentration of the sensor can be determined according to the sample. Moreover, even though a concentration of a target substance is completely unknown, its concentration can be determined by arranging nanochannels sensor different in optimum detection concentration on one and the same substrate without the need of another preliminary measurement. In addition, many types of chemical substances can simultaneously be detected by arranging nanochannel thin films having different recognition reagents on one and the same substrate.

6. Detection of a Potassium Ion

Thin films of impregnation-type sensors were impregnated with aqueous solutions of a fluorescent molecule recognition reagent to introduce the recognition reagent into nanochannels as in the case of the above FIG. 5.

N-(9-Anthrylmethyl)monoaza-18 crown-6 was used as the reagent.

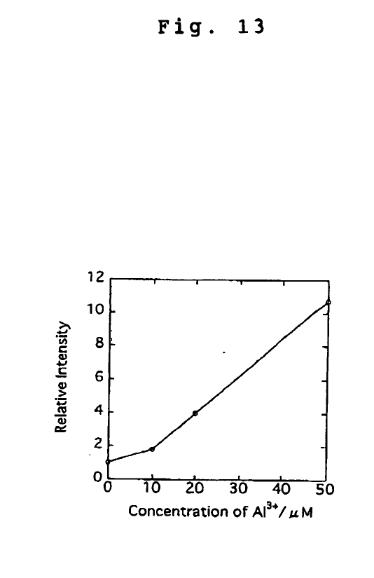

Subsequently, the thin films were impregnated with aqueous solutions of KCl and NaCl (adjusted to pH of 7.6) to measure a luminescent response to a potassium (K) ion and a sodium (Na) ion. The results were shown in FIG. 12.

From the results of FIG. 12, it is found that the fluorescence intensity is increased depending on the potassium ion concentration and there is almost no response to the sodium ion. That is, the sensor is excellent as a potassium ion-selective sensor.

And, the influence of the sodium ion at a high concentration which is present in the solution is quite low. In view of the foregoing, the sensor of this example can be used in the analysis of biosamples such as blood and urine.

7. Sensor Array

As in the foregoing manner, the thin film-forming solution was dropped on the glass substrate in plural positions, and dried with air to form an array structure in which plural circular spot-like (approximately 3 mm φ) nanochannel thin films were arrayed. Subsequently, this structure was impregnated with the Qs aqueous solutions as the luminescent molecule recognition reagent to introduce the same into the nanochannels.

Using the resulting sensor array, aluminum ion (Al³⁺) aqueous solutions having different concentrations were dropped on the respective spot-like nanochannel thin films to measure the luminescence on the circular spots.

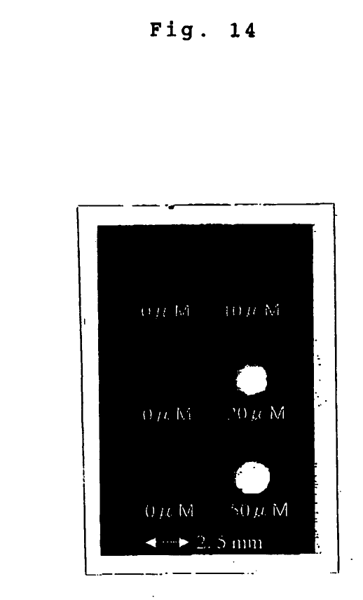

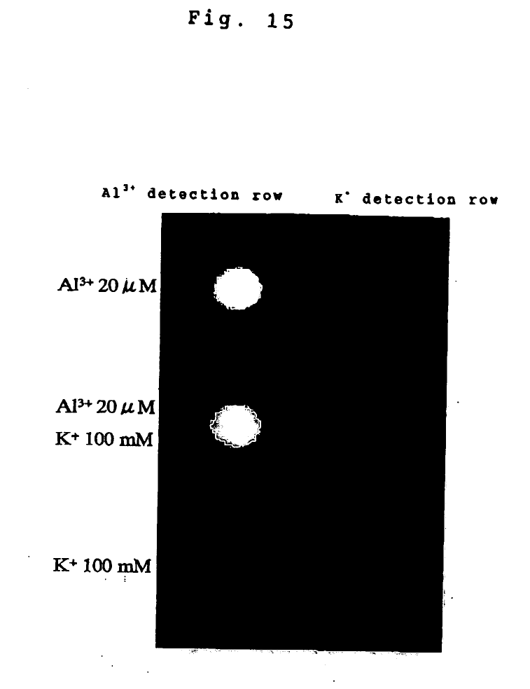

The results of the detection with a ⅓ color CCD camera detector at an excitation wavelength of 365 mm were shown in FIG. 13. The fluorescent images of the sensor array were shown in FIG. 14.

From these results, it is found that the structure of the sensor array makes it possible to measure plural sample solutions instantaneously and formation of a calibration curve using a standard solution and quantitative analysis of a sample can be completed by one measurement as shown in, for example, FIG. 13. Further, since the molecule recognition reagents and the like are trapped at high concentrations because of prominent substance trapping characteristics of the nanochannels, the fluorescence is strong. Accordingly, a CCD camera, a CMOS camera or a cellular phone with a common camera which is small-sized and power-saving can be used without the need of a costly, large-sized detector. Thus, a highly movable, small-sized measuring device can be constructed.

And, plural chemical species can also be detected simultaneously by impregnating thin film spots on one and the same substrate with fluorescent molecule recognition reagents different in function.

FIG. 15 shows its example. It is a photograph showing the results of the simultaneous analysis of an Al³⁺ ion and a K⁺ ion. In the Al³⁺ detection row, fluorescence is increased to the Al³⁺ solution, and there is no response to the K⁺ solution. The Al³ selective detection is thereby identified. Meanwhile, in the K⁺ detection row, fluorescence is increased to the K⁺ solution, and there is no response to the Al³⁺ solution.

The K⁺ selective detection is identified.

And, with respect to the solution in which Al³ and K⁺ are present, fluorescences of the corresponding detection sites are increased. Consequently, the simultaneous detection is identified.

### INDUSTRIAL APPLICABILITY

Upon focusing on the hydrophobic field provided by the presence of the surfactant which the nanochannels with pores of a nanometer size have therein, the invention of this application enables the novel development of the function as the sensor as described in detail.

1. A luminescent channel sensor which is a nanochannel sensor having a nanochannel thin film in which oxide layers have surfactant micelles therein, wherein the presence of a target substance in a sample solution is detected with a luminescence intensity of the thin film provided by recognition of the target substance with a luminescent recognition reagent in the nanochannels.

2. The luminescent nanochannel sensor of claim 1, wherein the oxide layer of the nanochannel is made mainly of silicon oxide.

3. The luminescent nanochannel sensor of claim 1, wherein the luminescent recognition reagent and the sample solution are mixed, the luminescent recognition reagent and the target substance recognized therewith are extractively trapped in the nanochannels, and the presence of the target substance in the sample solution is detected with the luminescence intensity of the thin film.

4. The luminescent nanochannel sensor of claim 1, wherein the nanochannels are previously impregnated with the luminescent recognition reagent, and the presence of the target substance in the sample solution is detected with the luminescence intensity of the thin film provided by the trapping recognition.

5. The luminescent nanochannel sensor of claim 2 wherein the luminescent recognition reagent and the sample solution are mixed, the luminescent recognition reagent and the target substance recognized therewith are extractively trapped in the nanochannels, and the presence of the target substance in the sample solution is detected with the luminescence intensity of the thin film.

6. The luminescent nanochannel sensor of claim 2 wherein the nanochannels are previously impregnated with the luminescent recognition reagent, and the presence of the target substance in the sample solution is detected with the luminescence intensity of the thin film provided by the trapping recognition.
